(19) United States
(12) Patent Application Publication
(10) Pub. No.: US 2026/0302978 A1
(43) Pub. Date: Oct. 1, 2026

(54) GENERATOR SET CONTROL BASED ON LOAD CONNDITION

(71) Applicant: Cummins Power Generation Inc., Minneapolis, MN (US)

(72) Inventors: Kai Wang, Columbus, IN (US); Yifeng Shen, Beiing (CN); Naputt Areethamsirikul, Minneapolis, MN (US); Michael James Scheuerell, Minneapolis, MN (US); Dexiu Zhao, Beijing (CN); Shujun Wang, Beijing (CN)

(73) Assignee: Cummins Power Generation Inc., Minneapolis, MN (US)

(21) Appl. No.: 18/831,436

(22) PCT Filed: Jul. 26, 2022
(86) PCT No.: PCT/CN2022/107975

§ 371 Date: Jan. 24, 2025

(51) Int. Cl. H02P 9/04; H02P 101/25

(52) U.S. Cl. CPC H02P 9/04; H02P 2101/25

(57) ABSTRACT

A generator set adaptively provides power based on a load condition. In one aspect, a generator set includes an engine(110) and an alternator(120) coupled to the engine(110). In one aspect, the alternator(120) is configured to generate a voltage at an output port, based on a speed of the engine(110). In one aspect, the generator set includes a controller(150) coupled to the engine(110) and the alternator(120). In one aspect, the controller(150) is configured to determine a load condition at the output port of the alternator(120). In one aspect, the controller(150) is configured to generate, based on the load condition, a control signal causing the engine(110) to change the speed to adjust a frequency or a phase of the voltage.

### TECHNICAL FIELD

The present application relates generally to systems and methods for adaptively controlling generator set(s) based on a load condition.

### BACKGROUND

Generator sets (gensets), such as alternating current (AC) gensets, can provide electrical power to loads when power is unavailable from an electric utility or another power source (e.g., a solar generator set, a fuel cell generator set, a wind generator set, etc.). When the utility power returns, the load can be transferred back to the utility. Further, gensets can supplement power of the utility when demand of the load exceeds the supply of the utility. Often, a load condition can change, and cause disruption in power provided by a genset. For example, a new load can be added, removed, enabled, or disabled. Change in the load condition can cause the genset to provide power with inadequate frequency, phase, and/or magnitude.

### SUMMARY

Disclosed herein are related to an apparatus or a generator set for providing a voltage at an output port based on a load condition. In some embodiments, the generator set includes an engine, and an alternator coupled to the engine. In some embodiments, the alternator is configured to generate the voltage at the output port, based on a speed of the engine. In some embodiments, the generator set includes a controller coupled to the engine and the alternator. In some embodiments, the controller includes one or more processors to execute or perform various functionalities of the controller described herein. In some embodiments, the controller is configured to determine the load condition at the output port of the alternator. In some embodiments, the controller is configured to generate, based on the load condition, a control signal causing the engine to change the speed to adjust a frequency or a phase of the voltage.

In one aspect, the controller is configured to detect an amplitude of the voltage. In one aspect, the controller is configured to detect a current through the output port. In one aspect, the controller is configured to determine the load condition, based on the amplitude of the voltage and the current.

In one aspect, the load condition includes an impedance at the output port. In one aspect, the controller is configured to determine an electrical load demand, based on a function of a target amplitude of the voltage and the impedance.

In one aspect, the controller is configured to generate, based on the electrical load demand, another control signal causing the alternator to change the amplitude of the voltage.

In one aspect, the generator set further includes an alternator controller coupled to the alternator. In one aspect, the alternator controller is configured to receive the another control signal indicating an amount of electromotive force of the alternator. In one aspect, the alternator controller is configured to provide the amount of electromotive force indicated by the another control signal to the alternator to adjust the amplitude of the voltage based on the load condition.

In one aspect, the load condition further includes a phase offset between the voltage and the current. In one aspect, the controller is configured to determine an adjusted electrical load demand, based on the electrical load demand and the phase offset.

In one aspect, the controller is configured to determine a mechanical power demand corresponding to the adjusted electrical load demand. In one aspect, the controller is configured to determine an amount of fuel to provide to the engine, based on the mechanical power demand. In one aspect, the controller is configured to generate the control signal indicating the amount of fuel.

In one aspect, the generator set further includes an engine controller coupled to the engine. In one aspect, the engine controller is configured to receive the control signal indicating the amount of fuel. In one aspect, the engine controller is configured to provide the amount of fuel indicated by the control signal to the engine to adjust the speed of the engine based on the load condition.

Disclosed herein are related to a method of controlling a generator set including a controller, an alternator, and an engine, based on a load condition at an output port of the alternator. In some embodiments, the method includes determining, by the controller, the load condition at the output port of the alternator. In some embodiments, the alternator is configured to generate a voltage at the output port, based on a speed of the engine coupled to the alternator. In some embodiments, the method includes generating, by the controller based on the load condition, a control signal to adjust an amplitude of the voltage at the output port.

In one aspect, the load condition includes an impedance at the output port. In one aspect, the control signal is generated by the controller based on the impedance.

In one aspect, the method includes dividing, by the controller, a value of the voltage by a value of a current through the output port to determine the impedance at the output port.

In one aspect, the method includes determining, by the controller, an electrical load demand based on the impedance. In one aspect, the control signal is generated by the controller based on the electrical load demand.

In one aspect, the method includes generating, by the controller based on the electrical load demand, another control signal to adjust the speed of the engine.

In one aspect, the method includes providing, by the controller, the control signal to an alternator controller. In one aspect, the alternator controller is configured to adjust electromotive force provided to the alternator according to the control signal to adjust the amplitude of the voltage at the output port.

In one aspect, the method includes providing, by the controller, the another control signal to an engine controller. In one aspect, the engine controller is configured to adjust an amount of fuel provided to the engine to adjust the speed of the engine according to the another control signal.

In one aspect, generating, by the controller based on the electrical load demand, the another control signal includes determining, by the controller, a mechanical power demand corresponding to the electrical load demand. In one aspect, generating, by the controller based on the electrical load demand, the another control signal includes generating, by the controller, the another control signal according to the determined mechanical power demand.

Disclosed herein are related to a non-transitory computer readable medium storing instructions when executed by one or more processors cause the one or more processors to perform various methods disclosed herein.

Disclosed herein are related to a generator set to provide a voltage at an output port based on a load condition. In some embodiments, the generator set includes an engine and an alternator coupled to the engine. In some embodiments, the alternator is configured to generate the voltage at the output port based on a speed of the engine. In some embodiments, the generator set includes a controller coupled to the engine and the alternator. In some embodiments, the controller is configured determine an impedance at the output port. In some embodiments, the controller is configured to generate, based on the impedance, a first control signal causing the engine to change a speed to adjust a frequency or a phase of the voltage. In some embodiments, the controller is configured to generate, based on the impedance, a second control signal causing the alternator to change an amplitude of the voltage.

In one aspect, the controller is configured to generate, based on the impedance, the first control signal indicating an amount of fuel to supply to the engine. In one aspect, the generator set includes an engine controller coupled to the engine. In one aspect, the engine controller is configured to receive the first control signal indicating the amount of fuel. In one aspect, the engine controller is configured to provide the amount of fuel indicated by the first control signal to the engine to change the speed of the engine based on the impedance.

In one aspect, the controller is configured to generate, based on the impedance, the second control signal indicating an amount of electromotive force of the alternator. In one aspect, the generator set includes an alternator controller coupled to the alternator. In one aspect, the alternator controller is configured to receive the second control signal indicating the amount of electromotive force of the alternator. In one aspect, the alternator controller is configured to provide the amount of electromotive force indicated by the second control signal to the alternator to change the amplitude of the voltage based on the load condition.

Disclosed herein are related to a method of controlling a generator set based on a load condition to provide power. In some embodiments, the generator set includes a controller, an alternator, and an engine. In some embodiments, the method includes determining, by the controller, the load condition at an output port of the alternator. The alternator can generate a voltage at the output port, based on a speed of the engine coupled to the alternator. In some embodiments, the method includes generating, by the controller based on the load condition, a control signal causing the engine to change the speed of the engine to adjust a frequency or a phase of the voltage.

In one aspect, the method further includes detecting, by the controller, an amplitude of the voltage. In one aspect, the method further includes detecting, by the controller, a current through the output port. In one aspect, the method further includes determining, by the controller, the load condition, based on the amplitude of the voltage and the current.

In one aspect, the load condition includes an impedance at the output port. In one aspect, the method further includes determining, by the controller, an electrical load demand, based on a function of a target amplitude of the voltage and the impedance.

In one aspect, the method further includes generating, by the controller based on the electrical load demand, another control signal causing the alternator to change the amplitude of the voltage.

In one aspect, the generator set includes an alternator controller coupled to the alternator. In one aspect, the method further includes receiving, by the alternator controller, the another control signal indicating an amount of electromotive force of the alternator. In one aspect, the method further includes providing, by the alternator controller, the amount of electromotive force indicated by the another control signal to the alternator to adjust the amplitude of the voltage based on the load condition.

In one aspect, the load condition further includes a phase offset between the voltage and the current. In one aspect, the method further includes determining, by the controller, an adjusted electrical load demand, based on the electrical load demand and the phase offset.

In one aspect, the method further includes determining, by the controller, a mechanical power demand corresponding to the adjusted electrical load demand. In one aspect, the method further includes determining, by the controller, an amount of fuel to provide to the engine, based on the mechanical power demand. In one aspect, the method further includes generating, by the controller, the control signal indicating the amount of fuel.

In one aspect, the generator set includes an engine controller coupled to the engine. In one aspect, the method further includes receiving, by the engine controller, the control signal indicating the amount of fuel. In one aspect, the method further includes providing, by the engine controller, the amount of fuel indicated by the control signal to the engine to adjust the speed of the engine based on the load condition.

Disclosed herein are related to a non-transitory computer readable medium for providing power. In some embodiments, the non-transitory computer readable medium stores instructions when executed by one or more processors cause the one or more processors to determine a load condition at an output port of an alternator. The alternator can be configured to generate a voltage at the output port, based on a speed of an engine coupled to the alternator. In some embodiments, the non-transitory computer readable medium stores instructions when executed by the one or more processors cause the one or more processors to generate, based on the load condition, a control signal causing the engine to change the speed of the engine to adjust a frequency or a phase of the voltage.

In one aspect, the non-transitory computer readable medium further stores instructions when executed by the one or more processors cause the one or more processors to detect an amplitude of the voltage. In one aspect, the non-transitory computer readable medium further stores instructions when executed by the one or more processors cause the one or more processors to detect a current through the output port. In one aspect, the non-transitory computer readable medium further stores instructions when executed by the one or more processors cause the one or more processors to determine the load condition, based on the amplitude of the voltage and the current.

In one aspect, the load condition includes an impedance at the output port. In one aspect, the non-transitory computer readable medium further stores instructions when executed by the one or more processors cause the one or more processors to determine an electrical load demand, based on a function of a target amplitude of the voltage and the impedance. In one aspect, the non-transitory computer readable medium further stores instructions when executed by the one or more processors cause the one or more processors to generate, based on the electrical load demand, another control signal causing the alternator to change the amplitude of the voltage. In one aspect, the non-transitory computer readable medium further stores instructions when executed by the one or more processors cause the one or more processors to determine an adjusted electrical load demand, based on the electrical load demand and the phase offset.

In one aspect, the non-transitory computer readable medium further stores instructions when executed by the one or more processors cause the one or more processors to determine a mechanical power demand corresponding to the adjusted electrical load demand. In one aspect, the non-transitory computer readable medium further stores instructions when executed by the one or more processors cause the one or more processors to determine an amount of fuel to provide to the engine, based on the mechanical power demand. In one aspect, the non-transitory computer readable medium further stores instructions when executed by the one or more processors cause the one or more processors to generate the control signal indicating the amount of fuel.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of an example generator set;

FIG. 2 is a detailed block diagram of the example generator set in FIG. 1;

FIG. 3 shows a method of providing electric power based on a load condition;

FIG. 4 shows a method of controlling an engine to adjust a frequency and a phase of a voltage, based on a load condition;

FIG. 5 shows a method of controlling an alternator to adjust an amplitude of the voltage, based on the load condition;

FIG. 6 shows a plot showing power provided by gensets, in response to a change in a load condition; and

FIG. 7 shows a plot showing engine speeds of gensets, in response to a change in a load condition.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

### Overview

Following below are more detailed descriptions of various concepts related to, and implementations of, methods, apparatuses, and for providing electrical power. The various concepts introduced above and discussed in greater detail below can be implemented in any of numerous ways, as the described concepts are not limited to any particular manner of implementation. Examples of specific implementations and applications are provided primarily for illustrative purposes.

Disclosed herein are related to a genset that adaptively provides power based on a load condition. In one aspect, a genset includes an engine and an alternator coupled to the engine. In one aspect, the alternator is configured to generate a voltage at an output port, based on a speed of the engine. In one aspect, the genset includes a controller coupled to the engine and the alternator. In one aspect, the controller is configured to determine a load condition at the output port of the alternator. In one aspect, the controller is configured to generate, based on the load condition, a control signal causing the engine to change the speed to adjust a frequency and/or a phase of the voltage. Examples of the load condition includes an impedance at the output port, a phase offset between the voltage and the current at the output port, etc. In one aspect, the controller is configured to generate, based on the load condition, another control signal causing the alternator to change an amplitude of the voltage.

Advantageously, the genset disclosed herein can provide power in a prompt and reliable manner, in response to a change in a load condition. In one implementation, a genset can regulate or control a voltage to have a target amplitude (or voltage set point) and to have a frequency and/or a phase corresponding to the speed of the engine (or speed set point). However, regulating or controlling the voltage based on the voltage set point and the speed set point can be slow and may not conform to standards such as ISO 8528-5. In one aspect, the genset disclosed herein can detect or determine a load condition at the output of the genset, and regulate or control the voltage according to the detected or determined load condition. For example, the genset can determine a speed of the engine to compensate for the change in the determined load condition, and cause the engine to run or operate at the determined speed to achieve a target frequency and/or a target phase of the voltage. For example, the genset can determine an electromotive force of the alternator to compensate for the change in the determined load condition, and cause the alternator to run or operate according to the electromotive force to achieve the target amplitude of the voltage. Accordingly, the genset disclosed herein can respond promptly to the change in the load condition.

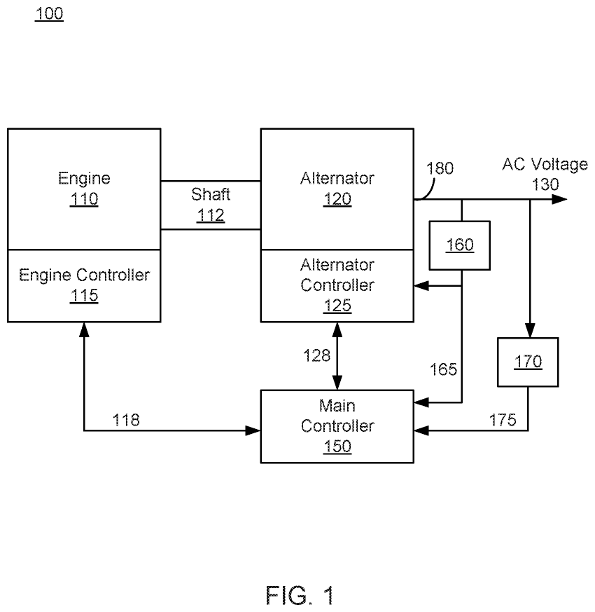

FIG. 1 is a block diagram of an example system, apparatus, or genset 100. In some embodiments, the genset 100 includes an engine 110, an engine controller 115, a shaft 112, an alternator 120, an alternator controller 125, a voltage sensor 160, a current sensor 170, and a main controller 150. These components can operate together to generate alternating current (AC) power, and provide the AC power to a load. In some embodiments, the genset 100 includes more, fewer, or different components than shown in FIG. 1. In some embodiments, the main controller 150, the engine controller 115, and the alternator controller 125 are embodied as logic circuits or application specific integrated circuits (ASIC). In some embodiments, the main controller 150, the engine controller 115, and the alternator controller 125 are implemented by a processor and a non-transitory computer readable medium storing instructions when executed by the processor cause the processor to perform or execute various functions of the main controller 150, the engine controller 115, and the alternator controller 125 described herein. In some embodiments, components of the genset 100 can be arranged in a different configuration than shown in FIG. 1. For example, the voltage sensor 160 can be a part of the alternator controller 125 or the main controller 150. For example, the current sensor 170 can be a part of the main controller 150. For example, the engine controller 115, the alternator controller 125, the main controller 150 or any combination of them can be embodied as a single component.

In some embodiments, the engine 110 is a machine or a mechanical component that generates mechanical energy or mechanical force. In one configuration, the engine 110 is coupled to the engine controller 115 and is coupled to the alternator 120 through a shaft 112. In some embodiments, the engine controller 115 is a component that controls the engine 110. In some embodiments, the shaft 112 is a mechanical component that rotates, according to the mechanical force generated the engine 110. In one configuration, the engine controller 115 is coupled to the main controller 150 through a communication link 118, and receives a control signal from the main controller 150 through the communication link 118. According to the control signal, the engine controller 115 can provide fuel to the engine 110 or cause the engine 110 to intake fuel. Based on combustion of the intake fuel, the engine 110 can generate the mechanical force to rotate the shaft 112. The engine 110 can rotate or spin the shaft 112 at a speed corresponding to an amount of fuel.

In some embodiments, the alternator 120 is a component that converts a mechanical energy or mechanical force into an electrical energy. In one configuration, the alternator 120 is coupled to the engine 110 through the shaft 112. In one configuration, the alternator 120 is coupled to the alternator controller 125. In some embodiments, the alternator controller 125 is a component that controls the alternator 120. In one configuration, the alternator controller 125 is coupled to the main controller 150 through a communication link 128 to receive a control signal indicating a target amplitude (or voltage set point) of an AC voltage 130 or an amount of electromotive force corresponding to the target amplitude from the main controller 150 through the communication link 128. In one configuration, the alternator controller 125 is coupled to the voltage sensor 160 through a communication link 165 (e.g., conductive rail or conductive wire) to receive a sensor signal indicating an amplitude of the AC voltage 130 from the voltage sensor 160 through the communication link 165. According to the control signal and the sensor signal, the alternator controller 125 can control or determine an amount of electromotive force of the alternator 120. The alternator controller 125 can provide the amount of electromotive force indicated by the another control signal to the alternator 120 to adjust the amplitude of the AC voltage 130 based on the load condition, such that the amplitude of the AC voltage 130 can be close to the target amplitude. According to the speed of rotation of the shaft 112 and the amount of electromotive force, the alternator 120 can generate the AC voltage 130 at an output port 180 of the alternator 120. For example, a phase or a frequency of the AC voltage 130 can correspond to the speed of the rotation of the shaft 112. For example, an amplitude of the AC voltage 130 can correspond to the amount of electromotive force.

In some embodiments, the voltage sensor 160 is a circuit or a component that detects the AC voltage 130 at the output port 180 of the alternator 120. In one configuration, the voltage sensor 160 is coupled to the output port 180 of the alternator 120 to receive or detect the AC voltage 130. In one configuration, the voltage sensor 160 is coupled to the alternator controller 125 and the main controller 150 through the communication link 165 to transmit or provide a sensor signal indicating the detected AC voltage 130. In some embodiments, the voltage sensor 160 is embodied as part of the alternator controller 125 or the main controller 150.

In some embodiments, the current sensor 170 is a circuit or a component that detects current through the output port 180 of the alternator 120. In one configuration, the current sensor 170 is coupled to the output port 180 of the alternator 120 to receive or detect the current through the output port 180 of the alternator 120. In one configuration, the current sensor 170 is coupled to the main controller 150 through a communication link 175 (e.g., conductive rail or conductive wire) to provide a sensor signal indicating the detected current. In some embodiments, the current sensor 170 is embodied as part of the main controller 150.

In some embodiments, the main controller 150 is a component that configures or controls the engine controller 115 and the alternator controller 125. In one configuration, the main controller 150 is coupled to the engine controller 115 through the communication link 118. In one configuration, the main controller 150 is coupled to the alternator controller 125 through the communication link 128. In this configuration, the main controller 150 can transmit or provide a signal indicating a target engine speed (or speed set point) corresponding to a frequency and/or phase of the AC voltage 130 to the engine controller 115. In addition, the main controller 150 can transmit or provide a signal indicating a target amplitude (or voltage set point) of the AC voltage 130 to the alternator controller 125.

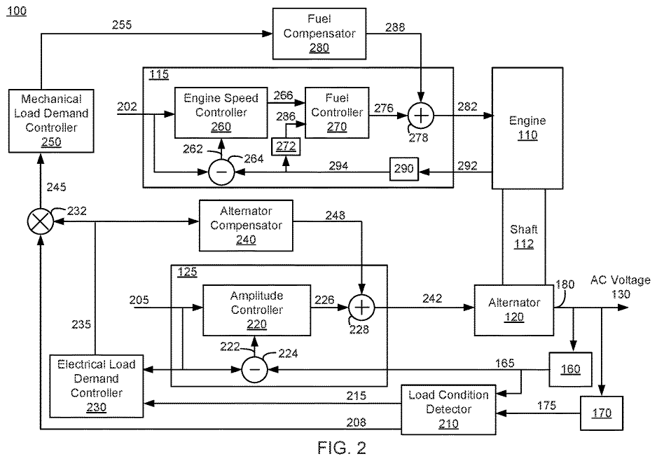

In some embodiments, the main controller 150 configures or controls the engine controller 115 and the alternator controller 125, according to a load condition. An example of the load condition includes an impedance at the output port 180, a phase offset between the AC voltage 130 and the current, etc. In one configuration, the main controller 150 is coupled to the voltage sensor 160 to receive, through the communication link 165, the sensor signal indicating the detected AC voltage 130. In one configuration, the main controller 150 is coupled to the current sensor 170 to receive, through the communication link 175, the sensor signal indicating the detected current. In this configuration, the main controller 150 can determine the load condition, according to the detected AC voltage 130 and the detected current indicated by the sensor signals. For example, the main controller 150 can divide the detected AC voltage 130 by the current to determine an impedance at the output port 180. For example, the main controller 150 can compare a time difference between a peak of the voltage and a peak of the current to determine the phase offset. According to the determined load condition, the main controller 150 can generate one or more control signals to configure or control the engine controller 115 and the alternator controller 125 to compensate for a change in the load condition. For example, the main controller 150 can transmit or provide a control signal indicating an amount of fuel to set or control a speed of the engine 110 corresponding to a frequency and/or a phase of the AC voltage 130. Additionally or alternatively, the main controller 150 can transmit or provide a control signal indicating an amount of electromotive force to set or control an electromotive force of the alternator 120 corresponding to an amplitude of the AC voltage 130. Detailed descriptions on implementations and operations of the main controller 150 are provided below with respect to FIGS. 2-7.

Advantageously, the genset 100 disclosed herein can provide power (or the AC voltage 130) in a prompt and reliable manner, in response to a change in a load condition. Regulating or controlling the AC voltage 130 based on the voltage set point and the speed set point can be slow and may not conform to standards such as ISO 8528-5. In one aspect, the genset 100 can detect or determine a load condition at the output port 180 of the alternator 120, and regulate or control the AC voltage 130 according to the detected or determined load condition. For example, the genset 100 can determine a speed of the engine 110 to compensate for the change in the determined load condition, and cause the engine 110 to run or operate at the determined speed to achieve a target frequency and/or a target phase of the AC voltage 130. For example, the genset 100 can determine an electromotive force of the alternator 120 to compensate for the change in the determined load condition, and cause the alternator 120 to run or operate according to the determined electromotive force to achieve the target amplitude of the AC voltage 130. Accordingly, the genset 100 disclosed herein can respond promptly to the change in the load condition.

FIG. 2 is a detailed block diagram of the example genset 100. In some embodiments, the genset 100 includes a fuel compensator 280, a mechanical load demand controller 250, an alternator compensator 240, an electrical load demand controller 230, a multiplier 232, and a load condition detector 210, in addition to the engine 110, the engine controller 115, the shaft 112, the alternator 120, the voltage sensor 160, and the current sensor 170 as described above with respect to FIG. 1. In some embodiments, some of these components are embodied as logic circuits or ASIC. In some embodiments, some of these components are implemented as a processor and a non-transitory computer readable medium storing instructions executable by the processor. In some embodiments, the fuel compensator 280, the mechanical load demand controller 250, the alternator compensator 240, the electrical load demand controller 230, and the load condition detector 210 are embodied as the main controller 150. In some embodiments, the mechanical load demand controller 250 and the fuel compensator 280 are embodied as part of the engine controller 115. In some embodiments, the alternator compensator 240, the electrical load demand controller 230 and the load condition detector 210 are embodied as part of the alternator controller 125. In some embodiments, the genset 100 includes more, fewer, or different components than shown in FIG. 2. In some embodiments, components of the genset 100 can be arranged in a different configuration than shown in FIG. 2.

In some embodiments, the load condition detector 210 is a component that determines the load condition according to a value of the AC voltage 130 detected by the voltage sensor 160 and a value of the current detected by the current sensor 170. The load condition detector 210 can divide the value of the detected AC voltage 130 by the value of the current to determine an impedance 215 at the output port 180. The load condition detector 210 can provide a value of the impedance 215 to the electrical load demand controller 230. The load condition detector 210 can compare a time difference between a peak of the AC voltage 130 and a peak of the current to determine a phase offset o between the AC voltage 130 and the current. According to the phase offset q, the load condition detector 210 can determine a power factor 208. For example, the load condition detector 210 can determine the power factor 208, according to a function cos(p). The load condition detector 210 can provide the power factor 208 to the multiplier 232.

In some embodiments, the electrical load demand controller 230 is a component that determines the electrical load demand 235 according to the voltage set point 205 and a value of the impedance 215. The electrical load demand controller 230 can determine the electrical load demand 235, according to the function (Uᵣ)²/|Z|, where Uᵣ is the voltage set point 205, and the |Z|is a magnitude of the impedance 215. In one aspect, the electrical load demand controller 230 provides the determined electrical load demand 235 to the multiplier 232 and the alternator compensator 240.

In some embodiments, the alternator compensator 240 is a component that determines the electromotive force compensation to compensate for the change in the load condition. The alternator compensator 240 can determine a target current I corresponding to the change in the load condition, according to the function Uᵣ/|Z|. The alternator compensator 240 can divide the electrical load demand 235 by U, to determine or obtain a value of the target current I. According to the value of the target current I, the alternator compensator 240 can determine the electromotive force compensation, according to the function Uᵣ+I*R+j*I*Xs, where R is a real part of an inherent impedance of the alternator 120 and X is an imaginary part of the inherent impedance of the alternator 120. In one aspect, the alternator compensator 240 generates a control signal 248 indicating the determined electromotive force compensation, and provides the control signal 248 indicating the determined electromotive force compensation to the alternator controller 125.

In some embodiments, the multiplier 232 is a component that determines an adjusted electrical load demand 245. In one aspect, the electrical load demand 235 is adjusted according to the phase offset o of impedance at the output port 180. The multiplier 232 can determine the adjusted electrical load demand 245 by multiplying the electrical load demand 235 with the power factor 208 or cos(φ). In one aspect, the multiplier 232 provides the adjusted electrical load demand 245 to the mechanical load demand controller 250.

In some embodiments, the mechanical load demand controller 250 is a component that determines a mechanical power demand 255 corresponding to the adjusted electrical load demand 245. In one approach, the mechanical load demand controller 250 determines an efficiency η of the engine 110, according to the adjusted electrical load demand 245. The mechanical load demand controller 250 can implement a look up table storing different power efficiency values η for corresponding adjusted electrical load demand values. The mechanical load demand controller 250 can apply the adjusted electrical load demand 245 to the look up table to determine a corresponding power efficiency value η. In one approach, the mechanical load demand controller 250 determines the mechanical power demand 255, according to the function Pₘ-P₂/η, where Pₘ is the mechanical power demand 255 and P₂ is power corresponding to the adjusted electrical load demand 245. In one aspect, the mechanical load demand controller 250 provides the mechanical power demand 255 to the fuel compensator 280.

In some embodiments, the fuel compensator 280 is a component that determines the fuel compensation to compensate for the change in the load condition. The fuel compensator 280 can determine torque demand T corresponding to the mechanical power demand 255. In one approach, the fuel compensator 280 determines the torque demand T, according to the function T=Pₘ*α, where α is a coefficient. The fuel compensator 280 can determine the fuel compensation corresponding to the torque demand T. For example, the fuel compensator 280 implements a look up table storing different fuel compensator values for corresponding torque demand values. The fuel compensator 280 can apply the torque value to the look up table to determine a corresponding fuel compensator value. In one aspect, the fuel compensator 280 -15 generates a control signal 288 indicating the fuel compensation, and provides the control signal 288 to the engine controller 115.

In some embodiments, the engine controller 115 includes an engine speed controller 260, a fuel controller 270, an engine interface 278, a differentiator 272, an engine speed detector 290, and a subtractor 264. These components can operate together to control the engine 110, according to a speed set point 202 and the fuel compensation. In some embodiments, some of these components are embodied as logic circuits or ASIC. In some embodiments, some of these components are implemented as a processor and a non-transitory computer readable medium storing instructions executable by the processor to perform functionalities of the engine controller 115 described herein. In some embodiments, the engine controller 115 includes more, fewer, or different components than shown in FIG. 2. In some embodiments, components of the engine controller 115 can be arranged in a different configuration than shown in FIG. 2.

In some embodiments, the engine speed detector 290 is a component that detects a speed of rotation of the engine 110, and generates the speed value 294 indicating the detected speed. In one aspect, the engine speed detector 290 provides the detected speed value 294 to the subtractor 264 and the differentiator 272.

In some embodiments, the subtractor 264 is a component that determines or generates an error value 262. The subtractor 264 can determine a difference between the speed set point 202 (or a target speed of the engine 110) and the detected speed value 294, and provide the difference as the error value 262. In one aspect, the subtractor 264 provides the error value 262 to the engine speed controller 260.

In some embodiments, the engine speed controller 260 is a component that determines a differential speed 266 to control the engine 110. In one approach, the engine speed controller 260 receives the speed set point 202 (or target speed of the engine 110) and the error value 262. The engine speed controller 260 can determine or generate the differential speed 266 according to the speed set point 202 and the error value 262. In one aspect, the differential speed 266 correspond to a target acceleration or a target torque value. In one approach, the engine speed controller 260 generates the differential speed 266 to cause the speed of the engine 110 to be close to the speed set point 202 or to cause the error value 262 to be close to zero.

In some embodiments, the differentiator 272 is a component that obtains a derivative 286 of the speed value 294. In some embodiments, the differentiator 272 is embodied as or includes one or more registers. In one aspect, the differentiator 272 can delay the speed value 294 by one or more clock cycles to obtain the derivative 286 of the speed value 294. In one aspect, the derivative 286 of the speed value 294 corresponds to a detected acceleration or a detected torque value.

In some embodiments, the fuel controller 270 is a component that determines an amount of fuel to provide to the engine 110. In one approach, the fuel controller 270 receives the differential speed 266 and the derivative 286 of the speed value 294. The fuel controller 270 can determine the amount of fuel, according to the differential speed 266 and the derivative 286 of the speed value 294. In one approach, the fuel controller 270 determines the amount of fuel to cause the differential speed 266 and the derivative 286 of the speed value 294 to be close to each other. In some embodiments, the fuel controller 270 generates a signal 276 indicating the determined amount of fuel, and provides the signal 276 to the engine interface 278.

In some embodiments, the engine interface 278 is a component that provides fuel 282 to the engine 110 or causes the engine 110 to intake fuel 282, according to the signal 276 indicating the determined amount of fuel and the control signal 288 indicating the fuel compensation. The engine interface 278 can adjust the amount of fuel indicated by the signal 276 according to the fuel compensation indicated by the control signal 288 to compensate for the change in the load condition. In one approach, the engine interface 278 determines the adjusted amount fuel to be a sum of the determined amount of fuel indicated by the signal 276 and the fuel compensation indicated by the control signal 288. The engine interface 278 can provide the adjusted amount of fuel 282 to the engine 110 or cause the engine 110 to intake the adjusted amount of fuel 282. In some embodiments, the engine interface 278 can be embodied as part of the engine 110.

In some embodiments, the alternator controller 125 includes an amplitude controller 220, an alternator interface 228, and a subtractor 224. These components can operate together to control the alternator 120, according to the voltage set point 205 and the electromotive force compensation indicated by the control signal 248. In some embodiments, some of these components are embodied as logic circuits or ASIC. In some embodiments, some of these components are implemented as a processor and a non-transitory computer readable medium storing instructions executable by the processor to perform functionalities of the alternator controller 125 described herein. In some embodiments, the alternator controller 125 includes more, fewer, or different components than shown in FIG. 2. In some embodiments, components of the alternator controller 125 can be arranged in a different configuration than shown in FIG. 2.

In some embodiments, the subtractor 224 is a component that determines or generates an error value 222. The subtractor 224 can determine a difference between the voltage set point 205 and an amplitude of the detected AC voltage 130, and provide the difference as the error value 222. In one aspect, the subtractor 224 provides the error value 222 to the amplitude controller 220.

In some embodiments, the amplitude controller 220 is a component that determines electromotive force to control the alternator 120. In one approach, the amplitude controller 220 receives the voltage set point 205 and the error value 222. The amplitude controller 220 can determine the electromotive force according to the voltage set point 205 and the error value 222, such that an amplitude of the AC voltage 130 can be close to the voltage set point 205 or the error value 222 can be close to zero. In one approach, the amplitude controller 220 adjusts a pulse width of a pulse to generate a signal 226 (or excitation current) corresponding to the determined electromotive force, and provides the signal 226 (or excitation current) to the alternator interface 228.

In some embodiments, the alternator interface 228 is a component that adds or combines the electromotive force indicated by the signal 226 with the electromotive force compensation indicated by the control signal 248 to obtain the adjusted electromotive force 242. The alternator interface 228 can adjust the electromotive force according to the electromotive force compensation to compensate for the change in the load condition. In one approach, the alternator interface 228 determines the adjusted electromotive force 242 to be a sum of the electromotive force indicated by the signal 226 and the electromotive force compensation indicated by the control signal 248. The alternator interface 228 can provide the adjusted electromotive force 242 to the alternator 120 or cause the alternator 120 to generate the AC voltage 130 according to the adjusted electromotive force 242 to set or control an amplitude of the AC voltage 130. In some embodiments, the alternator interface 228 can be embodied as a coil, through which the signal 226 and the control signal 248 can be injected, where the alternator 120 can generate the AC voltage 130 having an amplitude corresponding to a sum of the signal 226 and the control signal 248 injected. In some embodiments, the alternator interface 228 can be embodied as part of the alternator 120.

The alternator 120 can generate the AC voltage 130, according to the adjusted electromotive force 242 and the speed of rotation of the shaft 112. For example, the alternator 120 can generate the AC voltage 130 having the amplitude corresponding to the adjusted electromotive force 242. For example, the alternator 120 can generate the AC voltage 130 having a frequency and/or phase corresponding to the speed of rotation of the shaft 112.

Advantageously, the genset 100 disclosed herein can provide power (or the AC voltage 130) in a prompt and reliable manner, in response to a change in a load condition. Regulating or controlling the AC voltage 130 based on the voltage set point 205 and the speed set point 202 can be slow and may not conform to standards such as ISO 8528-5. In one aspect, the genset 100 can detect or determine a load condition at the output port 180 of the alternator 120, and regulate or control the AC voltage 130 according to the detected or determined load condition. For example, the mechanical load demand controller 250 and the fuel compensator 280 can operate together to determine a speed of the engine 110 to compensate for the change in the determined load condition, and cause the engine 110 to run or operate at the determined speed to achieve a target frequency and/or a target phase of the AC voltage 130. For example, the load condition detector 210, the electrical load demand controller 230 and the alternator compensator 240 can operate together to determine an electromotive force of the alternator 120 to compensate for the change in the determined load condition, and cause the alternator 120 to run or operate according to the determined electromotive force to achieve the target amplitude of the AC voltage 130. Accordingly, the genset 100 disclosed herein can respond promptly to the change in the load condition.

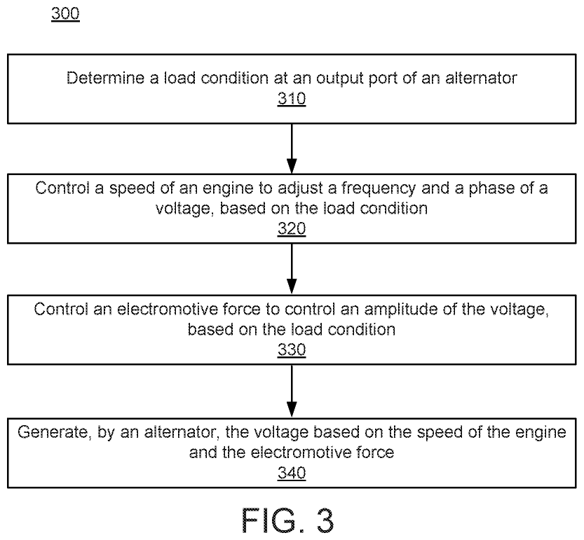

FIG. 3 shows a method 300 of providing electric power based on a load condition.

In some embodiments, the method 300 is performed by the genset 100. In some embodiments, the method 300 can be performed by any device or apparatus that provides an AC voltage. In some embodiments, the method 300 includes more, fewer, or different steps than shown in FIG. 3.

In one approach, the genset 100 determines 310 a load condition at an output port 180 of an alternator 120. Examples of the load condition includes an impedance at the output port 180, a phase offset between the voltage and the current at the output port 180, etc. In one approach, the genset 100 can receive or obtain a sensor signal indicating the detected AC voltage 130 at the output port 180 and a sensor signal indicating detected current through the output port 180. The genset 100 can determine the load condition, according to the detected AC voltage 130 and the detected current indicated by the sensor signals. For example, the genset 100 can divide a value of the detected AC voltage 130 by a value of the current to determine a value of an impedance at the output port 180. For example, the genset 100 can compare a time difference between a peak of the AC voltage 130 and a peak of the current to determine the phase offset.

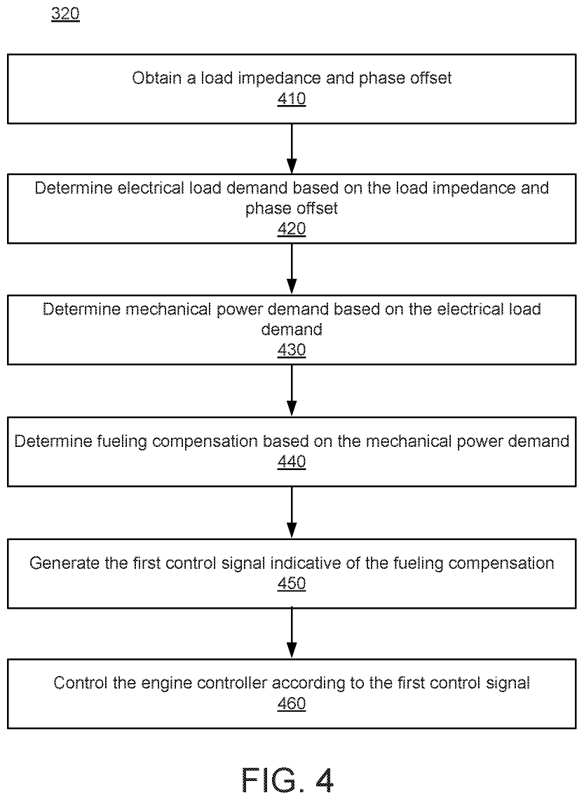

In one approach, the genset 100 controls 320 a speed of an engine 110 to adjust a frequency and a phase of the AC voltage 130, based on the load condition. For example, the genset 100 can determine a speed of the engine 110 to compensate for the change in the determined load condition, and cause the engine 110 to run or operate at the determined speed to achieve a target frequency and/or a target phase of the AC voltage 130. An example process of determining or controlling the speed of the engine 110 is provided below with respect to FIG. 4.

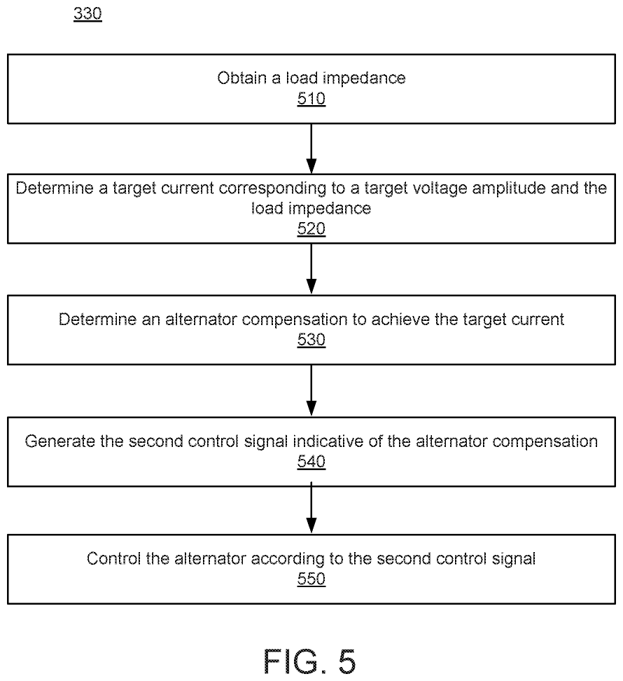

In one approach, the genset 100 controls 330 an electromotive force to control an amplitude of the AC voltage 130, based on the load condition. For example, the genset 100 can determine an electromotive force of the alternator 120 to compensate for the change in the determined load condition, and cause the alternator 120 to run or operate according to the electromotive force to achieve the target amplitude of the AC voltage 130. An example process of determining or controlling the electromotive force is provided below with respect to FIG. 5.

In one approach, the genset 100 generates 340, by an alternator 120, the AC voltage 130 based on the speed of the engine 110 and the electromotive force. For example, the alternator 120 can generate the AC voltage 130 having a phase or a frequency corresponding to the speed of the rotation of the shaft 112. For example, the alternator 120 can generate the AC voltage 130 having an amplitude corresponding to the amount of electromotive force.

FIG. 4 shows a method 320 of controlling an engine to adjust a frequency and a phase of a voltage, based on a load condition. In some embodiments, the method 320 is performed by the genset 100. In some embodiments, the method 320 can be performed by any device or apparatus that provides an AC voltage. In some embodiments, the method 320 includes more, fewer, or different steps than shown in FIG. 4.

In one approach, the genset 100 obtains 410 a load impedance and a phase offset. For example, the load condition detector 210 can determine or obtain a value of the load impedance and a value of the phase offset as described in the step 310.

In one approach, the genset 100 determines 420 electrical load demand based on the load impedance and impedance angle. For example, the electrical load demand controller 230 can determine the electrical load demand 235, according to the function (Uᵣ)²/|Z|, where Uᵣ is the voltage set point 205, and the |Z| is a magnitude of the impedance 215. The multiplier 232 can determine the adjusted electrical load demand 245 by multiplying the electrical load demand 235 with the power factor 208.

In one approach, the genset 100 determines 430 mechanical power demand based on the electrical load demand. For example, the mechanical load demand controller 250 determines an efficiency η of the engine 110, according to the adjusted electrical load demand 245. The mechanical load demand controller 250 can apply the adjusted electrical load demand 245 to a look up table to determine a corresponding power efficiency value η. In one approach, the mechanical load demand controller 250 determines the mechanical power demand 255, according to the function Pₘ-P₂/η, where Pₘ is the mechanical power demand 255 and P₂ is power corresponding to the adjusted electrical load demand 245.

In one approach, the genset 100 determines 440 fueling compensation based on the mechanical power demand. For example, the fuel compensator 280 can determine torque demand T corresponding to the mechanical power demand 255. In one approach, the fuel compensator 280 determines the torque demand T, according to the function T=Pₘ*α, where a is a coefficient. The fuel compensator 280 can determine the fuel compensation corresponding to the torque demand T. In one approach, the fuel compensator 280 can apply the torque demand value to the look up table to determine a corresponding fuel compensator value. In one approach, the fuel compensator 280 can determine the fuel compensation as a function of the torque demand T.

In one approach, the genset 100 generates 450 the first control signal indicative of the fueling compensation. For example, the fuel compensator 280 generates a control signal 288 indicating the fuel compensation.

In one approach, the genset 100 controls 460 the engine controller 115 according to the first control signal. For example, the engine controller 115 can adjust or modify, according to the control signal 288 indicating the fuel compensation, an amount of fuel to provide to the engine 110 determined based on the speed set point 202. Accordingly, the speed of the engine 110 can be controlled, in response to the change in the load condition in a prompt manner.

FIG. 5 shows a method 330 of controlling an alternator 120 to adjust an amplitude of the AC voltage 130, based on the load condition. In some embodiments, the method 330 is performed by the genset 100. In some embodiments, the method 330 can be performed by any device or apparatus that provides an AC voltage 130. In some embodiments, the method 330 includes more, fewer, or different steps than shown in FIG. 5.

In one approach, the genset 100 obtains 510 a load impedance. For example, the load condition detector 210 can determine a value of the load impedance as described in step 310.

In one approach, the genset 100 determines 520 a target current corresponding to a target voltage amplitude and the load impedance. For example, the alternator compensator 240 can determine a target current I corresponding to the change in the load condition, according to the function Uᵣ/|Z|.

In one approach, the genset 100 determines 530 an alternator compensation to achieve the target current. For example, according to the target current I, the alternator compensator 240 can determine the electromotive force compensation, according to the function Uᵣ+I*R+j*I*Xs, where R is a real part of an inherent impedance of the alternator 120 and X is an imaginary part of the inherent impedance of the alternator 120.

In one approach, the genset 100 generates 540 the second control signal indicative of the alternator compensation. For example, the alternator compensator 240 generates a control signal 248 indicating the determined electromotive force compensation.

In one approach, the genset 100 controls 550 the alternator 120 according to the second control signal. For example, the alternator controller 125 can adjust or modify, according to the control signal 248 indicating the electromotive force compensation, an amount of electromotive force of the alternator 120 determined based on the voltage set point 205.

Accordingly, the amplitude of the AC voltage 130 can be controlled, in response to the change in the load condition in a prompt manner.

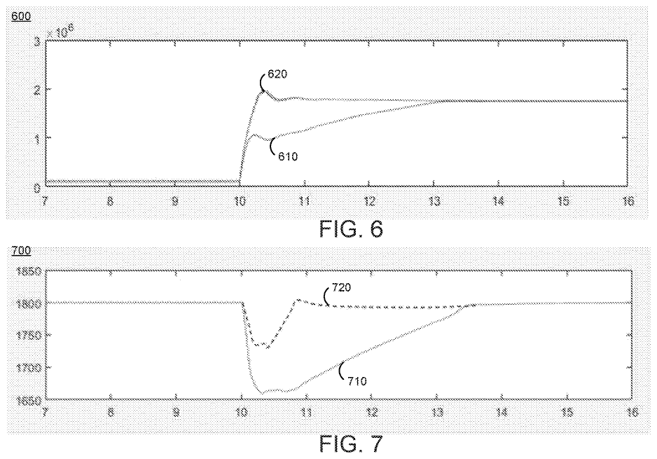

FIG. 6 shows a plot 600 showing power provided, in response to a change in a load condition. The plot 600 shows a curve 610 of power provided by the genset 100 without detecting the change in the load condition. In one aspect, the curve 610 represents the power provided by the genset 100 according to the set points 202, 205, while the load condition detector 210, the electrical load demand controller 230, the alternator compensator 240, the multiplier 232, the mechanical load demand controller 250, and the fuel compensator 280 are omitted or disabled. The plot 600 also shows a curve 620 of power provided by the genset 100 by detecting the change in the load condition and by generating the control signals 248, 288 to compensate for the change in the load condition. In one aspect, the curve 620 represents the power provide by the genset 100 according to the set points 202, 205 and the control signals 248, 288, while the load condition detector 210, the electrical load demand controller 230, the alternator compensator 240, the multiplier 232, the mechanical load demand controller 250, and the fuel compensator 280 are enabled. By generating the control signals 248, 288 to control the engine 110 and the alternator 120 based on the detected load condition, power or the AC voltage 130 provided by the genset 100 can reach a steady state promptly (e.g., within 1 second) as shown in the curve 620.

FIG. 7 shows a plot 700 showing a change in an engine speed, in response to a change in a load condition. The plot 700 shows a curve 710 of an engine speed when the genset 100 provides power without detecting the change in the load condition. In one aspect, the curve 710 represents the engine speed when the genset 100 provides power according to the set points 202, 205, while the load condition detector 210, the electrical load demand controller 230, the alternator compensator 240, the multiplier 232, the mechanical load demand controller 250, and the fuel compensator 280 are omitted or disabled. The plot 700 also shows a curve 720 of an engine speed when the genset 100 provides power by detecting the change in the load condition and by generating the control signals to compensate for the change in the load condition. In one aspect, the curve 720 represents the engine speed when the genset 100 provides power according to the set points 202, 205 and the control signals 248, 288, while the load condition detector 210, the electrical load demand controller 230, the alternator compensator 240, the multiplier 232, the mechanical load demand controller 250, and the fuel compensator 280 are enabled. By generating the control signals 248, 288 to control the engine 110 and the alternator 120 based on the detected load condition, the engine speed can reach a steady state promptly (e.g., within 1 second) as shown in the curve 720.

### Construction of Example Embodiments

While this specification contains many specific implementation details, these should not be construed as limitations on the scope of what can be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features can be described as acting in certain combinations and even initially claimed as such, one or more features from a claimed combination can, in some cases, be excised from the combination, and the claimed combination can be directed to a subcombination or variation of a subcombination.

As utilized herein, the terms “substantially,” generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled” and the like, as used herein, mean the joining of two components directly or indirectly to one another. Such joining can be stationary (e.g., permanent) or moveable (e.g., removable or releasable). Such joining can be achieved with the two components or the two components and any additional intermediate components being integrally formed as a single unitary body with one another, with the two components, or with the two components and any additional intermediate components being attached to one another.

It is important to note that the construction and arrangement of the system shown in the various example implementations is illustrative only and not restrictive in character. All changes and modifications that come within the spirit and/or scope of the described implementations are desired to be protected. It should be understood that some features may not be necessary, and implementations lacking the various features can be contemplated as within the scope of the application, the scope being defined by the claims that follow. When the language “a portion” is used, the item can include a portion and/or the entire item unless specifically stated to the contrary.

1. A controller to control a generator set to provide a voltage at an output port based on a load condition, the controller comprising:
one or more processors configured to:
determine the load condition at the output port of an alternator coupled to an engine, and
generate, based on the load condition, a control signal causing the engine to change a speed of the engine to adjust a frequency or a phase of the voltage.

2. The controller of claim 1, wherein the one or more processors are configured to:
detect an amplitude of the voltage,
detect a current through the output port, and
determine the load condition, based on the amplitude of the voltage and the current.

3. The controller of claim 2, wherein the load condition includes an impedance at the output port, wherein the one or more processors are configured to:
determine an electrical load demand, based on a function of a target amplitude of the voltage and the impedance.

4. The controller of claim 3, wherein the one or more processors are configured to generate, based on the electrical load demand, another control signal causing the alternator to change the amplitude of the voltage.

5. The controller of claim 3, wherein the load condition further includes a phase offset between the voltage and the current, wherein the one or more processors are configured to:
determine an adjusted electrical load demand, based on the electrical load demand and the phase offset.

6. The controller of claim 5, wherein the one or more processors are configured to:
determine a mechanical power demand corresponding to the adjusted electrical load demand,
determine an amount of fuel to provide to the engine, based on the mechanical power demand, and
generate the control signal indicating the amount of fuel.

7. A method of controlling a generator set including a controller, an alternator, and an engine, based on a load condition at an output port of the alternator, the method comprising:
determining, by the controller, the load condition at the output port of the alternator, the alternator configured to generate a voltage at the output port, based on a speed of the engine coupled to the alternator; and
generating, by the controller based on the load condition, a control signal to adjust an amplitude of the voltage at the output port.

8. The method of claim 7, wherein the load condition includes an impedance at the output port, wherein the control signal is generated by the controller based on the impedance.

9. The method of claim 8, further comprising:
dividing, by the controller, a value of the voltage by a value of a current through the output port to determine the impedance at the output port.

10. The method of claim 8, further comprising:
determining, by the controller, an electrical load demand based on the impedance, wherein the control signal is generated by the controller based on the electrical load demand.

11. The method of claim 10, further comprising:
generating, by the controller based on the electrical load demand, another control signal to adjust the speed of the engine.

12. The method of claim 11, further comprising:
providing, by the controller, the control signal to an alternator controller, the alternator controller to adjust electromotive force provided to the alternator according to the control signal to adjust the amplitude of the voltage at the output port.

13. The method of claim 12, further comprising:
providing, by the controller, the another control signal to an engine controller, the engine controller to adjust an amount of fuel provided to the engine to adjust the speed of the engine according to the another control signal.

14. The method of claim 11, wherein generating, by the controller based on the electrical load demand, the another control signal includes:
determining, by the controller, a mechanical power demand corresponding to the electrical load demand; and
generating, by the controller, the another control signal according to the determined mechanical power demand.

15. A non-transitory computer readable medium storing instructions when executed by one or more processors cause the one or more processors to perform the method of claim 7.

16. A generator set to provide a voltage at an output port based on a load condition, the generator set including:
an engine;
an alternator coupled to the engine, the alternator configured to generate the voltage at the output port based on a speed of the engine; and
a controller coupled to the engine and the alternator, the controller configured to:
determine an impedance at the output port,
generate, based on the impedance, a first control signal causing the engine to change a speed to adjust a frequency or a phase of the voltage, and
generate, based on the impedance, a second control signal causing the alternator to change an amplitude of the voltage.

17. The generator set of claim 16, wherein the controller is configured to generate, based on the impedance, the first control signal indicating an amount of fuel to supply to the engine.

18. The generator set of claim 17, further comprising:
an engine controller coupled to the engine, the engine controller configured to:
receive the first control signal indicating the amount of fuel, and
provide the amount of fuel indicated by the first control signal to the engine to change the speed of the engine based on the impedance.

19. The generator set of claim 16, wherein the controller is configured to generate, based on the impedance, the second control signal indicating an amount of electromotive force of the alternator.

20. The generator set of claim 19, further comprising:
an alternator controller coupled to the alternator, the alternator controller configured to:
receive the second control signal indicating the amount of electromotive force of the alternator, and
provide the amount of electromotive force indicated by the second control signal to the alternator to change the amplitude of the voltage based on the load condition.
